(19) United States
(12) Patent Application Publication
(10) Pub. No.: US 2019/0101047 A1
(43) Pub. Date: Apr. 4, 2019

(54) TWO-VALVE INTERNAL-COMBUSTION ENGINE

(71) Applicant: IFP Energies nouvelles, RUEIL-MALMAISON CEDEX (FR)

(72) Inventors: Didier AMBRAZAS, FRESNES (FR); Sebastien CHARMASSON, MASSY (FR); Xavier GAUTROT, RUEIL-MALMAISON (FR); Christophe LECHARD, MARLY LE ROI (FR); Julien TROST, PARIS (FR); Pierre VIOT, PARIS (FR)

(21) Appl. No.: 16/144,006

(22) Filed: Sep. 27, 2018

(30) Foreign Application Priority Data
Sep. 29, 2017 (FR) 17/59.057

(51) Int. Cl. F02B 23/10; F02F 1/24; F02F 1/18

(52) U.S. Cl. CPC F02B 23/101; F02B 2023/085; F02F 1/183; F02F 1/243

(57) ABSTRACT

The present invention relates to an internal-combustion engine comprising at least two cylinders wherein a piston in connection with a combustion chamber moves. Said combustion chamber comprises a single intake valve (SA), a single exhaust valve (SE), a single fuel injector (ID), two spark plugs (Al) and means for creating a swumble flow in said chamber.

### FIELD OF THE INVENTION

This invention relates to the field of direct-injection spark-ignition internal-combustion engines. More particularly, it relates to an engine usable in the road or aircraft sector, or in the field of stationary installations, a generator set for example.

This type of engine generally comprises at least a cylinder, a piston sliding in this cylinder in a reciprocating rectilinear motion, oxidizer intake means, burnt gas exhaust means, a combustion chamber and injection means for injecting fuel.

As it is well known, upon design of an engine, the performance, pollutant emission and combustion chamber mechanical strength objectives are increasingly demanding whereas the means for meeting them may oppose one another.

Thus, performance increase generally leads to an increase in emissions and to higher mechanical stresses.

To overcome these stresses and in order to guarantee low pollutant emissions and satisfactory mechanical strength over an entire engine operating range, it is essential for the fuel mixture (oxidizer/fuel) in the combustion chamber to be as homogeneous as possible.

### BACKGROUND OF THE INVENTION

Documents U.S. Pat. No. 6,267,107 and US-2005/241,612 describe a direct-injection high-squish combustion chamber whose ignition occurs through at least one plug, possibly with LIVC (Late Intake Valve Closure). Patents PH-2010/000,186 and U.S. Pat. No. 3,658,046 also mention a combustion chamber generating squish through a shape close to an ellipse coupled with a dual ignition device. However, none of the documents describes the architecture of the engine according to the invention, which comprises an optimized combination of combustion, ignition and supply means, and of mechanical engineering elements.

### SUMMARY OF THE INVENTION

The present invention thus relates to an internal-combustion engine comprising at least two cylinders wherein a piston in connection with a combustion chamber moves. According to the invention, said combustion chamber comprises a single intake valve, a single exhaust valve, a single fuel injector, two spark plugs and means for creating a swumble flow in said chamber.

Preferably, the internal-combustion engine can comprise three cylinders.

Said means for creating a swumble flow can comprise an optimization of the relative layout of the valves, the injector, and of the shape of the intake lines of the combustion chamber.

The cylinder head pattern can be achieved by symmetry through the plane passing through the axis of the cylinder head screws.

The exhaust manifold can be integrated in the cylinder head.

The injectors and the spark plugs may not run through the water or oil lines.

The single fuel injector can be arranged in the combustion chamber for direct fuel injection.

The combustion engine according to the invention can be used for running with a Miller or an Atkinson cycle.

The invention describes a novel architecture design for an internal-combustion engine specifically developed for high-efficiency spark ignition engines.

### BRIEF DESCRIPTION OF THE FIGURES

Other features and advantages of the device according to the invention will be clear from reading the description hereafter of embodiments given by way of non limitative example, with reference to the accompanying figures wherein:

FIG. 1 shows a graph of the evolution of the combustion rate as a function of the distribution law,

FIG. 2 illustrates a combustion chamber according to an embodiment of the invention,

FIG. 3 shows an embodiment of the cylinder head pattern,

FIG. 4 is an overall view with the serpentine-shaped seal path of the cylinder head, and

FIG. 5 illustrates the integrated exhaust manifold.

### DETAILED DESCRIPTION OF THE INVENTION

The increasingly stringent antipollution standards in Europe and worldwide compel engine manufacturers, whether engines intended for the aircraft or the road industry, to constantly improve them by bringing new ideas for internal-combustion engines. Although compression-ignition engines have long been well supported by users due to the higher efficiency thereof, they now suffer from a deteriorated image for public health reasons. Spark-ignition engines thus rank again among the key players in the evolution of internal-combustion engines. In order to meet the stringency of the normative evolutions, they need to integrate still more technologies and new ideas.

The present invention provides an innovative spark-ignition engine in that it is designed from a range of several existing technical solutions, combined for the first time and interacting so as to make up a breakthrough product in terms of energy performances, while remaining competitive as regards compactness, cost and durability.

One of the specific features of this engine is that it was developed with the initial constraint that it must be able to run with a Miller cycle over a wide operating range. The Miller cycle is characterized by closing of the intake valve(s) before the piston reaches bottom dead center. This enables to have a greater recovered work in addition to cooling of the charge admitted, and therefore a higher engine overall efficiency. However, this type of cycle has a very limited range of use for a conventional spark-ignition engine due to a not insignificant impact on the aerodynamics of the fuel mixture and, more specifically, a significant decrease in the combustion rate due to a sharp drop in the turbulent kinetic energy upon ignition.

In order to overcome this lack of turbulence upon ignition, an engine whose combustion chamber and aerodynamic intake structure comprise means for creating a flow referred to as swumble has been designed. Swumble consists of swirl (longitudinal motion) and of tumble (transverse motion).

Swirl, which is a macroscopic rotating motion of the fuel mixture around an axis collinear to the cylinder axis, is characterized by good motion conservation during the intake process, and more specifically during the rise of the piston. It is an aerodynamic macroscopic motion that is generally used for compression-ignition internal-combustion engines for which it is a good way to homogenize the fuel mixture.

Tumble is also a macroscopic rotating motion of the fuel mixture, but about an axis substantially perpendicular to the cylinder axis. It has the specific feature of turning into microscopic aerodynamic motions that create turbulence as the piston rises. It is an aerodynamic macroscopic motion that is generally used for spark-ignition internal-combustion engines for which it is a good way to obtain an acceptable combustion rate. Besides, this motion is quite sensitive to the combustion chamber geometry and to the lift law, in terms of spread as well as maximum lift height.

Thus, swumble can be defined as the rotational motion of air about the cylinder axis combined with a rotational motion about an axis perpendicular to the axis of said cylinder. Using swumble allows to benefit from the advantages of the two aerodynamic structures detailed above and thus from excellent homogenization and a better combustion rate, thanks to a higher turbulence level during the intake phase than the levels observed with the best current spark-ignition engines.

Thus, the range of use of the Miller cycle is therefore greatly widened.

In order to couple this specific swumble type intake with high compactness and moderate cost, the engine according to the invention only comprises two valves per cylinder, an intake valve and an exhaust valve, with a single direct injection and two ignition points. The shape of the intake pipe and of the combustion chamber, as well as the relative position of the injection and ignition devices, are the main means allowing a swumble type intake to be obtained. Indeed, these elements can be configured to initiate a rotational motion of air about the cylinder axis combined with a rotational motion about an axis perpendicular to the axis of said cylinder.

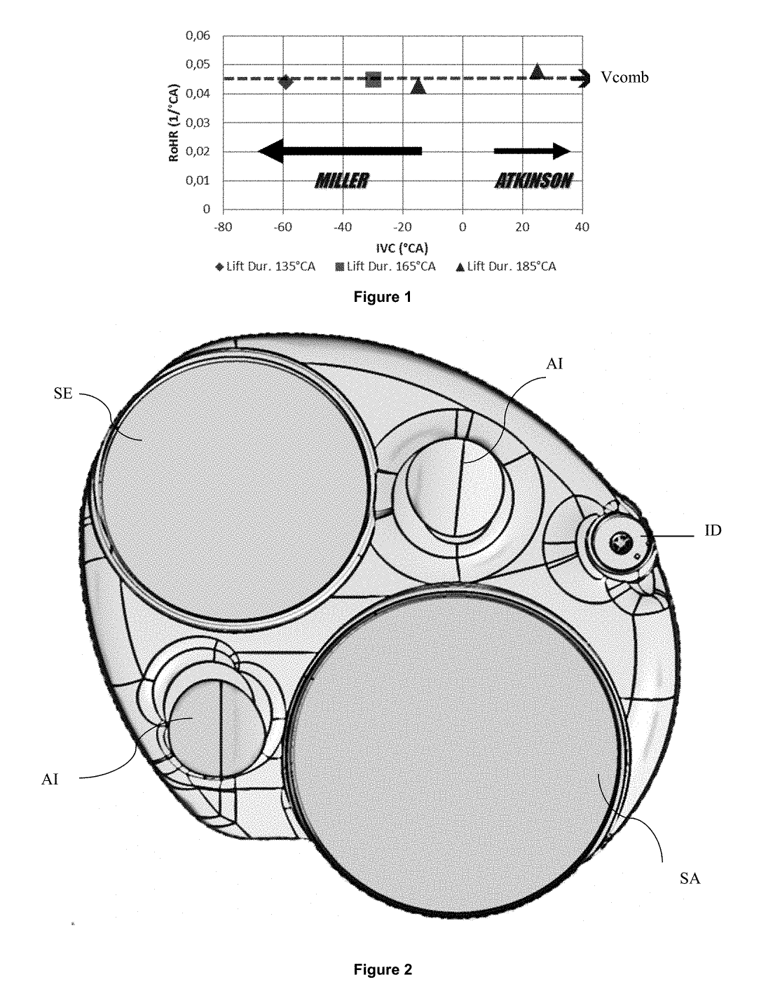

The present invention has been evaluated and compared with the best current spark-ignition engines. FIG. 1 shows the added value of the present invention by presenting the impact of the lift law on the combustion duration.

In the graph of FIG. 1, the abscissa shows the closing angle of the intake valve(s) (IVC). A negative value corresponds to closing before the bottom dead center (BDC) of the piston whereas a positive value corresponds to closing as the piston rises. The ordinate axis corresponds to the heat release rate that is representative of the combustion rate (R₀HR). The last variable is the lift law spread (Lift Dur). A limited spread (135° CA and 165° CA, with ° CA crank angle degree) corresponds to a specific lift law of the Miller cycle, while a normal spread (185° CA) corresponds to a conventional lift law. It is noted here that, whatever the lift law selected, combustion rate Vcomb is identical. In particular, we have identical combustion rates with a Miller cycle and a conventional cycle (Atkinson cycle), which shows the significance of the architecture of the engine according to the invention, which comprises swumble in a Miller cycle.

It is noted that the combustion rate is independent of the valve spread and timing law, which is not found with the current best spark-ignition engines. This shows that the overall efficiency of the internal-combustion engine according to the invention has improved noticeably.

FIGS. 2 to 5 show the various features of the present invention.

FIG. 2 describes a non limitative embodiment of the combustion chamber comprising an oxidizer intake valve SA, an exhaust valve SE, two ignition points Al and an injection point ID.

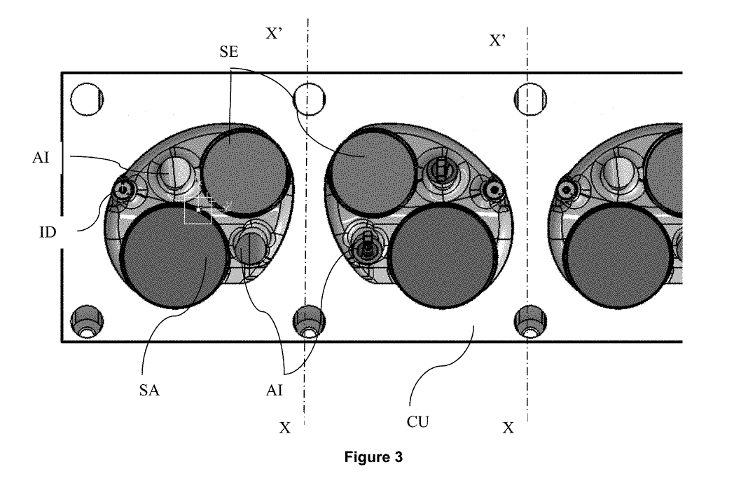

For compactness purposes, the cylinder head pattern selected is very specific so as to enable integration of all the secondary elements, such as the two plugs Al, injector ID, the two valves SA and SE, and to obtain good thermomechanical stability (FIG. 3). The cylinder head pattern is understood to be the representation, on the cylinder head of a heat engine, of a combustion chamber of the heat engine equipped with the secondary elements. Unlike the majority of cylinder heads where the pattern is achieved by simple translation for each cylinder, we use here a cylinder head pattern CU achieved by symmetry through a plane separating two consecutive combustion chambers (for example the plane passing through the axis of the cylinder head screws), axes XX′ in FIG. 3. In other words, for two consecutive cylinders, the layout of the secondary elements is symmetrical through plane XX corresponding here to the axis of the cylinder head screws.

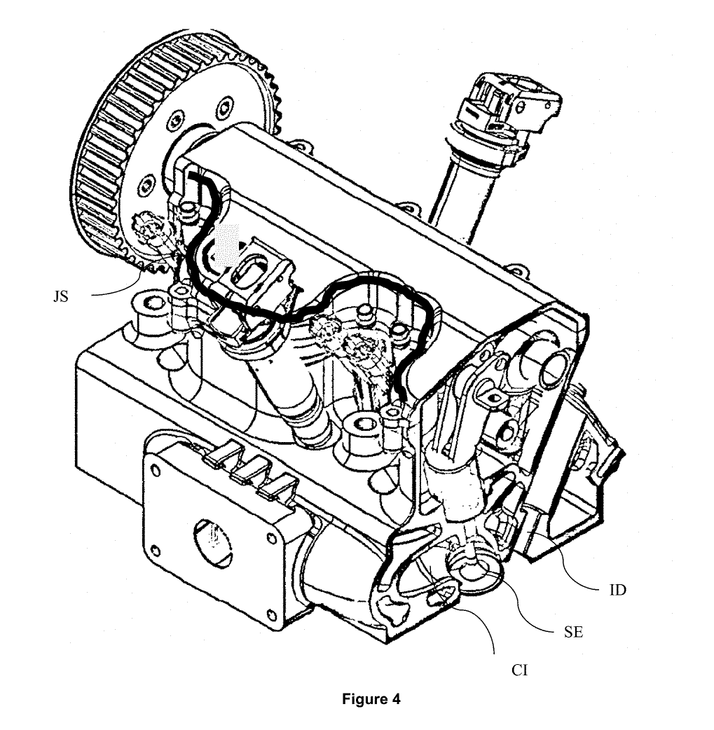

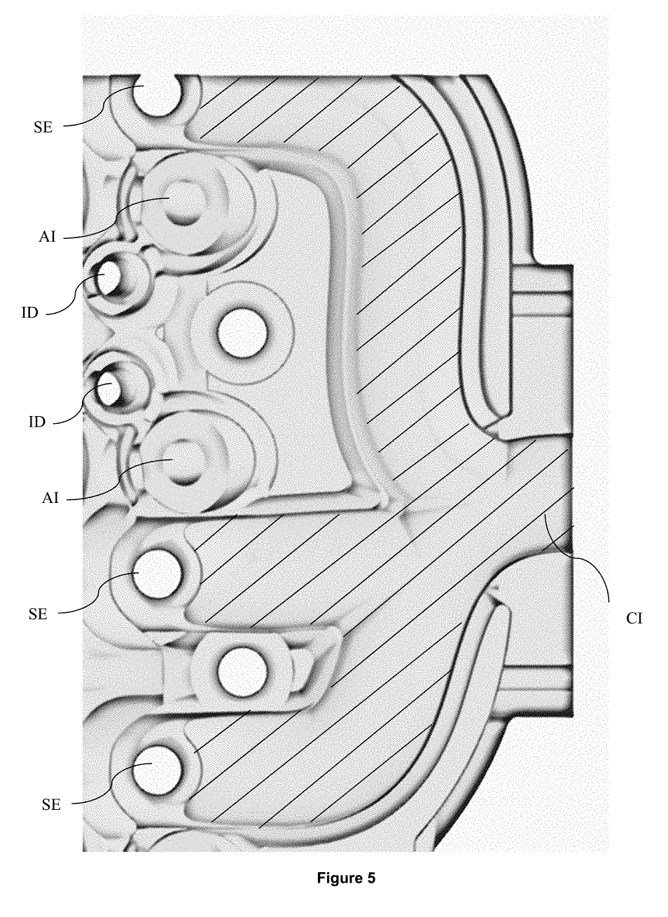

The result is a serpentine-shaped seal path between the cylinder head and the cylinder head cover specific to the present invention. Indeed, to prevent the design of sleeves, and therefore significant weight, cost and size, neither the plugs nor the injectors run through the water core or the oil core. The seal path therefore needs to bypass them. FIG. 4 shows the serpentine-shaped seal path visualized by line JS.

For compactness and performance purposes, the internal-combustion engine comprises three cylinders. However, the internal-combustion engine according to the invention comprises at least two cylinders.

FIGS. 4 and 5 illustrate the technical choice of implementing an exhaust manifold CI integrated in the cylinder head, which allows to address the performance, compactness and cost issues. The exhaust manifold is referred to as integrated in the cylinder head because the assembly made up of the cylinder head and the exhaust manifold is made of a single piece. Exhaust valve SE connects the combustion chamber (not shown) to integrated exhaust manifold Cl. This figure illustrates the position of injection means ID. Indeed, this technical choice allows to obtain these advantages through better control of the thermics around the exhaust pipes. In particular, in the presence of turbocharging, the thermal conditions of the exhaust gas at the turbine inlet are thus better controlled. Furthermore, manifold CI integrated in the cylinder head is more compact than a conventional solution where the length of engagement, notably for screws and bolts, needs to be taken into account. Finally, the cost is reduced due to the absence of a specific stainless steel manifold (for heat resistance) and of fastening elements therefor.

In the preferred configuration thereof, the present invention provides a valve gear solution using stop spacers with two concentric camshafts, but an architecture with two distinct camshafts is also entirely possible.

Finally, in its preferred embodiment, the engine has three cylinders supercharged by a mechanical turbocharger, but it could also very well operate in a configuration comprising at least two cylinders and for any (supercharged or not) air supply loop.

1. An internal-combustion engine comprising at least two cylinders wherein a piston in connection with a combustion chamber moves, wherein the combustion chamber comprises a single intake valve (SA), a single exhaust valve (SE), a single fuel injector (ID) for direct fuel injection, two spark plugs (Al) and means for creating a swumble flow in the chamber, i.e. a rotational motion of air about the cylinder axis combined with a rotational motion about an axis perpendicular to the axis of the cylinder.

2. An internal-combustion engine as claimed in claim 1, comprising three cylinders.

3. An internal-combustion engine as claimed in claim 1, wherein the means for creating a swumble flow comprise a relative layout of the valves and/or of the injector and/or a shape of the intake lines of the combustion chamber configured to initiate a rotational motion of air about the cylinder axis combined with a rotational motion about an axis perpendicular to the axis of the cylinder.

4. An internal-combustion engine as claimed in claim 1, wherein the cylinder head pattern is achieved by symmetry through the plane passing through the axis of the cylinder head screws (XX′).

5. An internal-combustion engine as claimed in claim 1, wherein the exhaust manifold (CI) is integrated in the cylinder head.

6. An internal-combustion engine as claimed in claim 1, wherein the injectors and the spark plugs do not run through the water or oil lines.

7. Use of a combustion engine as claimed in claim 1, for running with a Miller or Atkinson cycle.

8. A method of using the combustion engine as claimed in claim 1, comprising operating the combustion engine in a Miller cycle in which the intake valve closes before bottom dead center of the piston.

9. A method of using the combustion engine as claimed in claim 1, comprising operating the combustion engine in an Atkinson cycle in which the intake valve closes as the piston rises.
